(19) United States
(12) Patent Application Publication
(10) Pub. No.: US 2014/0302794 A1
(43) Pub. Date: Oct. 9, 2014

(54) CLOSE PROXIMITY BASED EVENT TRIGGERING

(71) Applicants: Arto Palin, Viiala (FI); Jari Nikara, Lempaala (FI); Petri Liuha, Lempaala (FI)

(72) Inventors: Arto Palin, Viiala (FI); Jari Nikara, Lempaala (FI); Petri Liuha, Lempaala (FI)

(21) Appl. No.: 14/361,694

(22) PCT Filed: Dec. 7, 2011
(86) PCT No.: PCT/FI2011/051078

§ 371 Date: May 29, 2014

(51) Int. Cl. H04W 76/02; H04W 8/00; H04W 4/00

(52) U.S. Cl. CPC H04W 76/02; H04W 4/008; H04W 8/005
USPC 455/41.2

(57) ABSTRACT

In accordance with an example embodiment of the present invention, an apparatus, a computer program product and a method is provided for device and/or user identification. The example embodiment comprises receiving, at an apparatus, a wireless signal comprising at least one of an address or an indication identifying a wireless communication device initiating the wireless signal, transmitting a query to a remote network entity, the query including at least one of the received address or indication identifying the wireless communication device and an indication associated with identity of the apparatus, and receiving a response to the query including information relating to identity of the wireless communication device if an association exists between the apparatus and the wireless communication device.

### TECHNICAL FIELD

The present application relates generally to wireless communication, more particularly to triggering actions relating to connection establishment between proximate apparatuses.

### BACKGROUND

Modern society has adopted, and is becoming reliant upon, wireless communication devices for various purposes, such as, connecting users of the wireless communication devices with other users. Wireless communication devices can vary from battery powered handheld devices to stationary household and/or commercial devices utilizing an electrical network as a power source. Due to rapid development of the wireless communication devices a number of areas capable of enabling entirely new types of communication applications have emerged.

In order to exchange information with other devices, a wireless communication device needs to first detect other devices that are within communication range. After device detection, one or more wireless communication links may be established with one or more of the other devices in order for the devices to communicate by way of exchanging information over a wireless network. While established wireless communication links allow devices to exchange information, the establishment of said wireless communication links consumes resources of the wireless communication device.

### SUMMARY

Various aspects of examples of the invention are set out in the claims.

According to a first aspect of the present invention, a method is provided comprising transmitting device discovery messages from an apparatus; receiving one or more response messages at the apparatus, each of the one or more response messages including information regarding a source apparatus of the response message. The method further comprising determining, by the apparatus, whether any of the one or more response messages satisfy a predetermined criteria for triggering a touch event; and when determining that a response message satisfies the predetermined criteria for triggering the touch event, initiating one or more actions relating to wireless connection establishment with the source apparatus of the response message, the one or more actions being dependent on the received information regarding the source apparatus of the response message.

According to a second aspect of the present invention, a computer program product is disclosed, adapted to cause performing of the method according to the first aspect when said program is run on a computer.

According to a third aspect of the present invention, an apparatus is disclosed, comprising means for transmitting device discovery messages; means for receiving one or more response messages, each of the one or more response messages including information regarding a source apparatus of the response message. The apparatus further comprising means for determining whether any of the one or more response messages satisfy a predetermined criteria for triggering a touch event; and means for initiating one or more actions relating to wireless connection establishment with the source apparatus of the response message when determining that a response message satisfies the predetermined criteria for triggering the touch event, the one or more actions being dependent on the received information regarding the source apparatus of the response message.

According to a fourth aspect of the present invention, an apparatus is disclosed, comprising at least one processor; and at least one memory including executable instructions, the at least one memory and the executable instructions being configured to, in cooperation with the at least one processor, cause the apparatus to perform at least the following: transmit device discovery messages; receive one or more response messages, each of the one or more response messages including information regarding a source apparatus of the response message; determine whether any of the one or more response messages satisfy a predetermined criteria for triggering a touch event; and when determining that a response message satisfies the predetermined criteria for triggering the touch event, initiate one or more actions relating to wireless connection establishment with the source apparatus of the response message, the one or more actions being dependent on the received information regarding the source apparatus of the response message.

According to a fifth aspect of the present invention, a computer program product is disclosed comprising computer executable code recorded on a non-transitory computer readable storage medium, the computer executable program code comprising: code configured transmit device discovery messages; code configured to receive one or more response messages, each of the one or more response messages including information regarding a source apparatus of the response message; code configured to determine whether any of the one or more response messages satisfy a predetermined criteria for triggering a touch event; and when determining that a response messages satisfies the predetermined criteria for triggering the touch event, code configured to initiate one or more actions relating to wireless connection establishment with the source apparatus of the response message, the one or more actions being dependent on the received information regarding the source apparatus of the response message.

The foregoing summary includes example embodiments of the present invention that are not intended to be limiting. The above embodiments are used merely to explain selected aspects or steps that may be utilized in implementations of the present invention. However, it is readily apparent that one or more aspects, or steps, pertaining to an example embodiment can be combined with one or more aspects, or steps, of other embodiments to create new embodiments still within the scope of the present invention. Therefore, persons of ordinary skill in the art would appreciate that various embodiments of the present invention may incorporate aspects from other embodiments, or may be implemented in combination with other embodiments.

### BRIEF DESCRIPTION OF THE DRAWINGS

For a more complete understanding of example embodiments of the present invention, reference is now made to the following descriptions taken in connection with the accompanying drawings in which:

FIG. 1 discloses an example of operational environment in which apparatuses according to an example embodiment of the invention may be used;

FIG. 2 illustrates an example Bluetooth™ communication protocol based device discovery with Extended Inquiry Response (EIR) procedure usable in accordance with at least one example embodiment;

FIG. 3 illustrates example data formats of information included in Frequency Hopping Synchronization (FHS) and Extended Inquiry Response (EIR) packets, usable in accordance with at least one example embodiment.

FIG. 4 discloses a modular layout for an example apparatus according to an example embodiment of the present invention;

FIG. 5 illustrates an example short-range communication scenario in accordance with at least one example embodiment of the present invention.

FIG. 6A illustrates an example short-range communication scenario in accordance with at least one example embodiment of the present invention;

FIG. 6B illustrates an example short-range communication scenario in accordance with at least one example embodiment of the present invention;

FIG. 7 illustrates an example flow diagram showing operations for initiating one or more actions at an apparatus in response to detecting that another apparatus is within a close proximity according to an example embodiment of the present invention;

FIG. 8 illustrates an example flow diagram showing operations for initiating one or more actions at a Bluetooth™ apparatus in response to detecting that another Bluetooth™ apparatus is within close proximity according to an example embodiment of the present invention;

FIG. 9 illustrates an example Bluetooth™ radio architecture according to an example embodiment of the present invention; and

FIG. 10 discloses an apparatus comprising example hardware for implementing computer software instructions stored in the apparatus according to an example embodiment of the present invention.

### DETAILED DESCRIPTION OF THE DRAWINGS

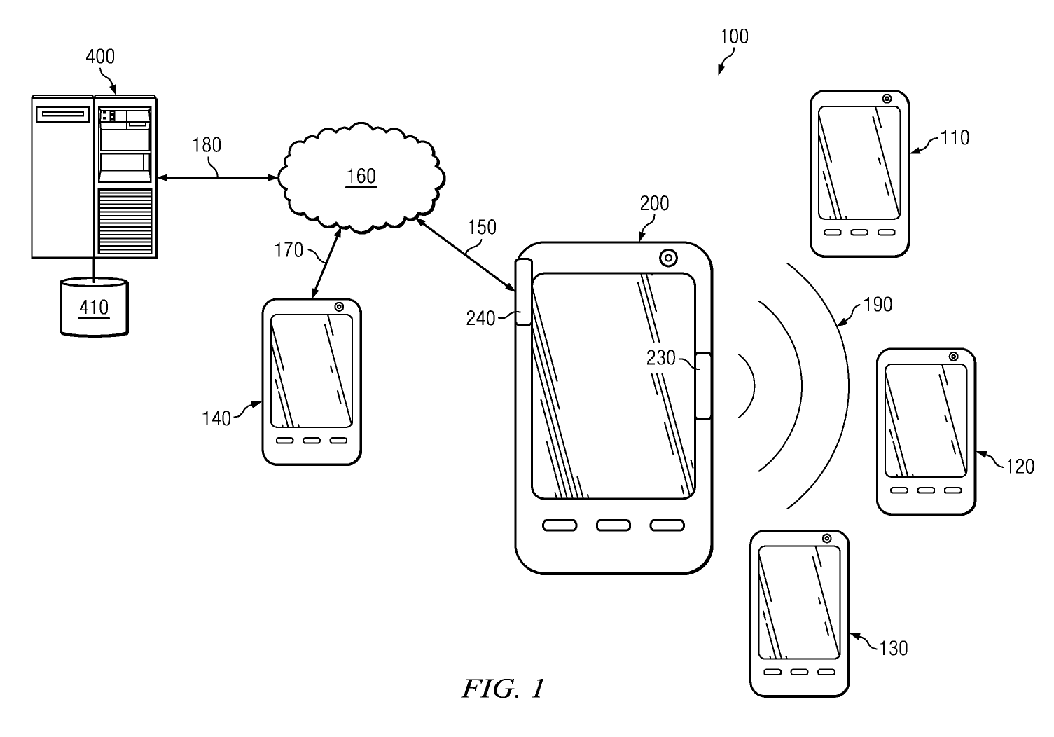

Example embodiments of the present invention and their potential effects are understood by referring to FIGS. 1 through 10 of the drawings.

FIG. 1 discloses an example of operational environment 100 in which various apparatuses according to an example embodiment of the invention may be used. An apparatus 200, for example a personal computer, an engineering workstation, a personal digital assistant, a portable computer, a computerized watch, a wired or wireless terminal, mobile phone, node, and/or the like, a set-top box, a personal video recorder (PVR), an automatic teller machine (ATM), a game console, or the like is shown having short-range communication means, such as a short-range communications interface 230, configured to communicate wirelessly with various short-range communication devices, such as devices 110, 120 and 130 via a short-range communication connection. Short-range communication connections may be used for the exchange of information over a local area varying for example from a couple of meters to some hundred of meters. Examples of wireless short-range communication technologies comprise Bluetooth™, Bluetooth™ Low Energy, WLAN, wireless universal serial bus (WUSB), ultra-wideband (UWB), ZigBee (802.15.4, 802.15.4a), and ultra high frequency radio-frequency identification (UHF RFID) technologies. Apparatus 200 may further be embodied as a portable wireless communications device equipped with wide-area communication means, such as long-range communications interface 240 to connect with network 160 via a wireless communication link 150 to communicate for example either with a wireless communication device 140, or with a remote server 400 as illustrated in FIG. 1.

Depending on the embodiment, the wireless communication link 150 may be provided over a wide-are communication connection. Examples of wireless wide-area communication technologies comprise 2^{nd} generation (2G) digital cellular networks, for example Global System for Mobile Communications (GSM) that operates in the 900 MHz/1.8 GHz bands in Europe and in the 850 MHz and 1.9 GHz bands in the United States. Wide-area communication technologies may further comprise general packet radio service (GPRS) technology, universal mobile telecommunications system (UMTS) technology, code division multiple access (CDMA) technologies, 3GPP Long Term Evolution (LTE) technologies, and/or the like.

According to an alternative example embodiment, link 150 may be provided with a wired connection. Examples of wired communication technologies include ethernet, IEEE 1394, universal serial bus (USB) protocol, any other serial or parallel wired connection, and/or the like. Network 160 may be either a wireless network, or a wired network. Network 160 may further be connected to other networks. According to a further example embodiment, apparatus 200 may be a stationary device having a wireless and/or a wired interface for communicating with network 160.

As further shown in FIG. 1 various other devices, such as other mobile device 140 and server 400 including a database 410 may be connected to the network 160 via respective links (170 and 180) so that apparatus 200 may communicate with any of the other devices via the network 160.

According to one example, apparatus 200, such as a wireless communication device, before actually initiating a wireless short-range communication with one or more other wireless communication devices, such as any of the devices 110, 120 or 130 through a wireless short-range communication link 190, needs to first perform device discovery to detect one or more of the devices 110, 120 and 130 within it's short-range communication coverage. After device discovery and selection, apparatus 200 may proceed with short-range communication link establishment in order to commence communication with one or more of the detected devices.

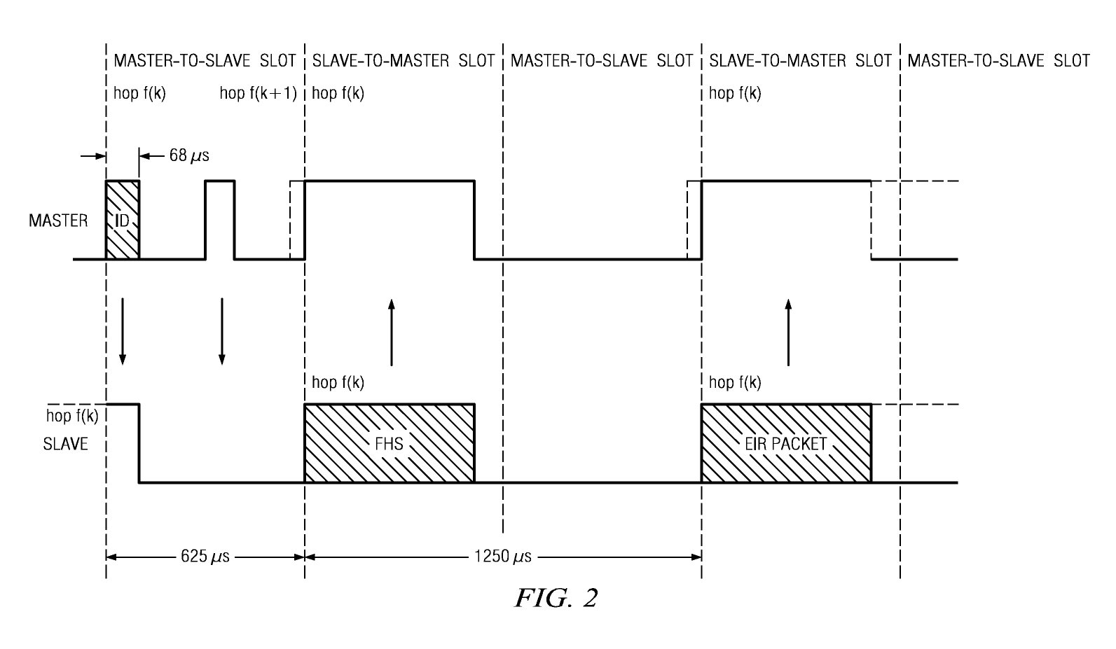

An example device discovery scenario usable in accordance with at least one example embodiment is illustrated in FIG. 2. This example discloses Bluetooth™ communication protocol based device discovery with Extended Inquiry Response (EIR) procedure. It should be noted that Bluetooth™ communication protocol in this context is intended to be used only as an example, and thus, other wireless communication protocols may be employed in implementing one or more embodiments of the present invention. Initially an apparatus, such as apparatus 200 of FIG. 1, may be configured to perform a Bluetooth™ Inquiry, i.e. trying to detect other Bluetooth™ devices within its coverage, by transmitting one or more ID packets. These ID packets transmitted by the apparatus do not contain any information about the source or recipient of the transmissions. However, the packets may indicate which class of devices should respond. Bluetooth™ Core Specification, version 4.0, published on Jun. 30, 2010 provided by Bluetooth™ Special Interest Group (SIG) accessible at www.bluetooth.org defines one general inquiry access code (GIAC) to inquire for any type of device, and multiple dedicated inquiry access codes (DIAC) that only inquire for certain type of device to respond to the ID packet.

Bluetooth™ Inquiry procedure may be performed in order to find discoverable Bluetooth™ devices within transmission range. As shown in FIG. 2, Inquiring device is a Master and any responding device is a Slave. Default duration of a Bluetooth™ Inquiry scan is 11.25 ms when performing a standard scan and 22.5 ms when performing an interlaced scan. Default value for a Bluetooth™ Inquiry scan interval is 2.56 s. In the example of FIG. 2, the master-to-slave slot duration is 625 μs, and the total master-to-slave and slave-to-master slot duration is 1250 μs. Apparatuses in a discoverable mode that receive Bluetooth™ Inquiry packets, such as one or more ID packets that typically have a duration of 68 μs, may transmit a response including a Frequency Hop Synchronization (FHS) packet.

As illustrated on the example Bluetooth™ communication protocol based device discovery with Extended Inquiry Response (EIR) of FIG. 2, an Extended Inquiry Response (EIR) packet may be transmitted by the responding device subsequent to the transmission of the FHS packet. The EIR packet may contain miscellaneous information in addition to what is delivered in the basic inquiry response (i.e. FHS packet). EIR packets may comprise information regarding, for example, services offered by the apparatus or some vendor specific information. The impending transmission of an EIR packet may be indicated by an EIR indicator bit that is set in the FHS packet. If it is indicated in the FHS packet that an EIR packet follows (i.e., the EIR bit is set), transmission of the EIR packet transmission initiates in the next slave-to-master slot. EIR packets may be asynchronous connectionless link (ACL) packets of type DM1, DM3, DM5, DH1, DH3 or DH5.

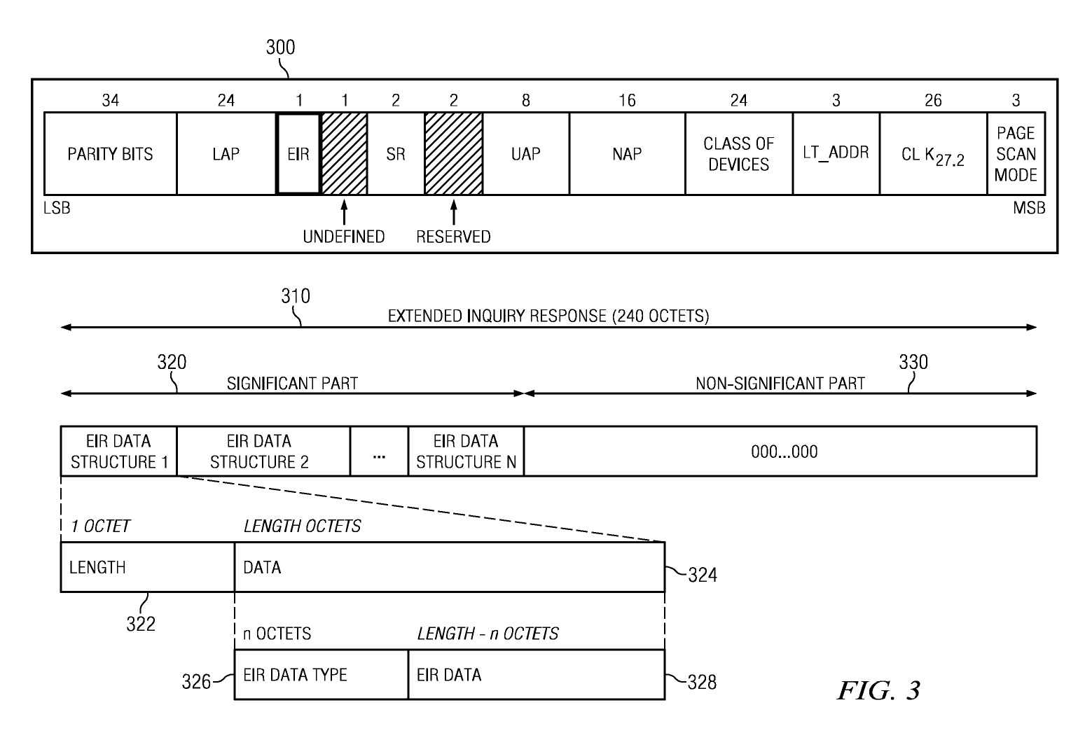

Example data format included in a FHS packet usable e.g. in connection with the example Bluetooth™ communication protocol based device discovery with Extended Inquiry Response (EIR) of FIG. 2, includes various elements as defined in the existing Bluetooth™ Core Specification, version 4.0, published on Jun. 30, 2010 provided by Bluetooth™ Special Interest Group (SIG), accessible at www.bluetooth.org. FIG. 3 illustrates data elements of an example FHS packet 300 usable in connection with the example Bluetooth™ communication protocol comprising at least a Bluetooth Device Address (BD_ADDR), which is formed of three address parts, Lower Address Part (LAP), Upper Address Part (UAP) and Non-significant Address Part (NAP), device class (CoD), indication whether an Extended Inquiry Response (EIR) follows the FHS packet, Bluetooth™ Page scan mode and clock phase. The Upper Address Part (UAP) and Non-significant Address Part (NAP) of the Bluetooth Device Address form identification of a manufacturing company of a Bluetooth device. The class of device (CoD) field defines the kind of device that is responding. As an example, the responding device's major class may be audio device and major class wearable headset device. Full description of the class of device information is provided by the Bluetooth Special Interest Group and accessible e.g. at: https://www.bluetooth.org/Technical/AssignedNumbers/baseband.htm.

An example data format of an EIR packet usable e.g. in connection with the example Bluetooth™ communication protocol based device discovery with Extended Inquiry Response (EIR) of FIG. 2 includes various elements as defined in the existing Bluetooth™ Core Specification, version 4.0, published on Jun. 30, 2010 provided by Bluetooth™ Special Interest Group (SIG), accessible at www.bluetooth.org. FIG. 3 illustrates data format of an example EIR packet 310, which includes 240 octets of data and comprises a significant part 320 and a non-significant part 330. The significant part 320 of the example EIR packet 310 contains a sequence of data structures. Each data structure have a length field 322 of one octet, which contains a length value for associated data field 324, and the data field 324 consisting payload for a number of octets corresponding to the length value of the length field 322. The first n octets 326 of the data field contain the extended inquiry response (EIR) data type. The content of the remaining length−n octets 328 in the data field depends on the value of the EIR data type and contains EIR data. The non-significant part 330 of the EIR packet 310 extends the extended inquiry response to 240 octets and contains all-zero octets. The example EIR packet 310 may include various information regarding the responding device, such as information regarding supported service classes, name information and transmission power level of the responding device. The complete list of service classes is provided by the Bluetooth Special Interest Group and accessible e.g. from here: https://www.bluetooth.org/Technical/AssignedNumbers/service_discovery.htm.

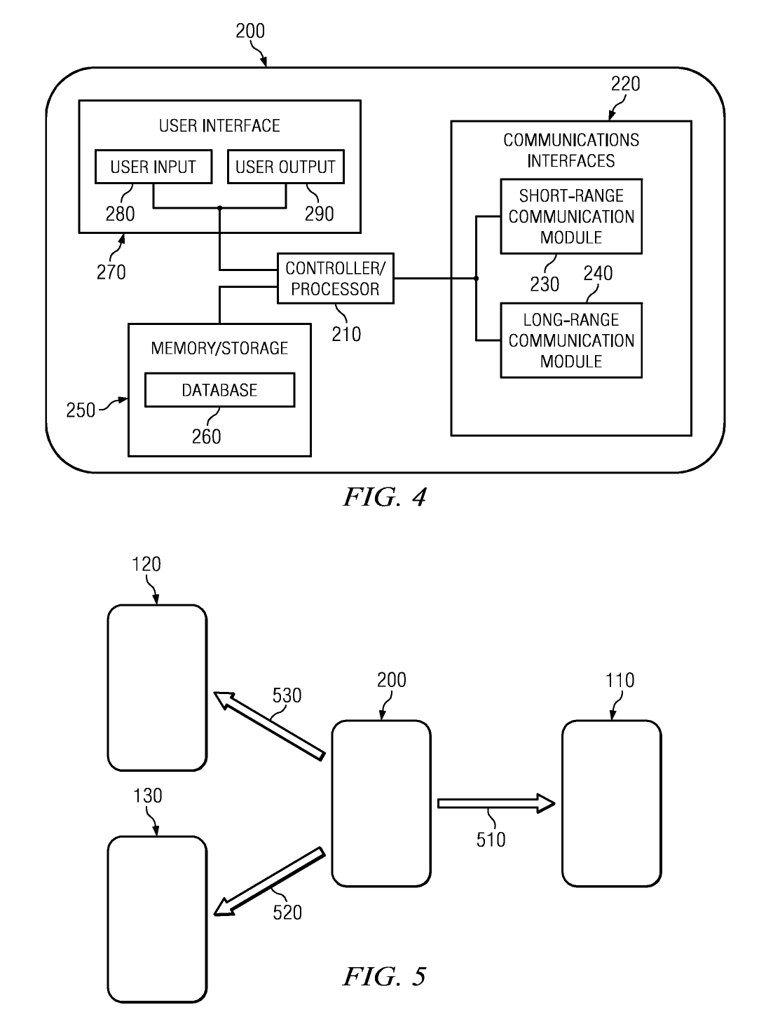

FIG. 4 discloses a modular layout for an example apparatus according to an example embodiment of the present invention. In FIG. 4, apparatus 200 of FIG. 2 is broken down into modules configured to cause the apparatus to perform various functionalities. The functionalities may be provided by various combinations of the software and/or hardware components discussed below according to an embodiment of the present invention.

Control module 210 is configured to regulate operation of the apparatus 200. The control module may be embodied as a controlling means, for example as a controlling circuitry or a processor. Inputs for the control module 210 may be received from various other modules comprised within apparatus 200. For example, user interface 270 may provide input to the control module 210 in response to receiving input from a user via user input 280. So, user input received via the user interface 270 may be used as an input in the control module 210 for controlling the operation of the apparatus 200. Control module 210 may interpret and/or process the input data and, in response, may issue one or more control commands to at least one of the other modules within apparatus 200.

In accordance with an example embodiment, apparatus 200, embodied for example as a wireless communication device, comprises communications interfaces 220. Communications interfaces 220 may incorporate one or more communication modules of the apparatus 200. In an example embodiment, the communications interfaces 220 may comprise means for wired and/or wireless communication. As shown in the example of FIG. 4, communications interfaces 220 may comprise a short-range communications module 230 and a long-range communications module 240. It should be understood that although FIG. 4 illustrates only one short-range communication module 230 and one long-range communication module 240 for the sake of clarity, apparatus 200 may comprise any number of further communications modules. For example, two or more additional wired and/or wireless communication modules may be included in the apparatus 200. Apparatus 200 may utilize one or more of these modules to receive information from both local and long distance sources, and to transmit data to recipient devices from apparatus 200. Communications interfaces 220 may be activated by control module 210, or by control resources local to the sub-modules responding to received messages, environmental influences and/or other devices in communication with the apparatus 200.

Short-range wireless networks provide communication solutions that avoid some of the problems seen in large cellular networks. Bluetooth™ is an example of a short-range wireless technology quickly gaining acceptance in the marketplace. Bluetooth™ enabled wireless communication device may transmit and receive data rates from 720 Kbps up to 2-3 Mbps within a range of 10 meters, and may transmit up to 100 meters with additional power boosting. A user does not actively instigate a Bluetooth™ network. Instead, a plurality of devices within operating range of each other will automatically form a network group called a “piconet”. Any device may promote itself to the master of the piconet, allowing it to control data exchanges with up to seven “active” slaves and 255 “parked” slaves. Active slaves exchange data based on the clock timing of the master. Parked slaves monitor a beacon signal in order to stay synchronized with the master, and wait for an active slot to become available. These devices continually switch between various active communication and power saving modes in order to transmit data to other piconet members. In addition to Bluetooth™ and Bluetooth™ Low Energy, other popular short-range wireless networks include WLAN (of which “Wi-Fi” local access points communicating in accordance with the IEEE 802.11 standard, is an example), WUSB, UWB, ZigBee (802.15.4, 802.15.4a), and UHF RFID. All of these wireless mediums have features and advantages that make them appropriate for various applications.

Short-range communication module 230 may comprise short-range communication interface embodied for example as a transmitter and/or receiver for exchanging information across short-range wireless network using a short-range communication protocol. Example communication protocols for short-range communication may comprise Bluetooth™, Bluetooth™ Low Energy, wireless local area network (WLAN), ultra-wide band (UWB), and wireless universal serial bus (WUSB) technologies. Bluetooth™ Low Energy communication protocol provides a security enhancing feature for creating temporary identification information that may be used to mask actual identification of the wireless communication device. The temporary identification information may be used by other devices in communicating with the apparatus 200. However, only other devices possessing secret address component information may determine the actual identity of the masked wireless communication device. The temporary identification information may further be recompiled when a threshold condition is satisfied.

Long-range communication module 240 may comprise a long-range communications interface configured to communicate and exchange information over a long distance in a large geographic area using any of the wide-area communication technologies described earlier. Examples of wireless long-range communication technologies comprise 2^{nd} generation (2G) digital cellular networks, for example Global System for Mobile Communications (GSM) that may communicate in the 900 MHz/1.8 GHz bands in Europe and in the 850 MHz and 1.9 GHz bands in the United States. Long-range communication technologies may further comprise general packet radio service (GPRS) technology, universal mobile telecommunications system (UMTS) technology, code division multiple access (CDMA) technologies, and/or the like. Long-range communication technologies may also operate to transmit and receive messages, such as text messages via a short messaging service (SMS), and/or multimedia content via multimedia messaging service (MMS) messages. Long-range communication technologies may provide voice and data services.

As a subset of long-range communications module 240, or alternatively operating as an independent module separately coupled to processor 210, the apparatus 200 may comprise a broadcast receiver. The broadcast receiver may be a digital audio- or video receiver, for example a digital audio broadcasting (DAB) or a digital video broadcasting (DVB) receiver, and/or the like. According to an example embodiment, the broadcast receiver comprises a Digital Video Broadcast for Handheld Apparatuses (DVB-H) receiver. The broadcasting transmissions may be encoded so that only certain apparatuses may access the transmitted content. The broadcast transmission may comprise text, audio and/or video information, and data. In an example embodiment, apparatus 200 may receive broadcasts and/or information within the broadcast signal to determine if the apparatus is permitted to view the received content.

According to one example embodiment either the short-range communications module 230, or the long-range communications module 240 may be equipped with a wired interface that may be used for communicating with another device using a wired communication protocol via an interface such as Ethernet, an IEEE 1394 communication interface, a universal serial bus (USB) interface, and/or the like.

User interface 270 may include visual, audible and/or tactile elements which allow a user to receive data from, and enter data into, the apparatus. Data entered by a user is received via user input module 280 and may be interpreted by control module 210, for example to affect the behavior of apparatus 200. User-inputted data may also be transmitted via any of the communication modules of the communications interfaces 220 to another device. Information may also be received by other devices at the apparatus 200 via communications interfaces 220. Control module 210 may cause this information to be transferred to user interface 270 for presentation to the user via user output module 290. User interface 270 may comprise one or more user input and output modules, and there may also be a module operating both as a user input module 280 and user output module 290, for example a touch screen display operating as a tactile user interface.

Apparatus 200 may further comprise a memory and/or storage 250. Memory/storage 250 may be connected to controller 210. Memory/storage 250 may include a database 260. The database 260 may comprise one or more data items, such as information related to original identification of the apparatus, and related data items for creating private address for masking the original identity of the apparatus 200. Memory/storage 250 may further store executable instructions that are configured to cause the apparatus 200 to perform various actions in co-operation with the control module 210. The memory/storage 250 may further maintain information regarding predetermined criteria for triggering touch events for example in the form of a dedicated database. In addition, the memory/storage 250 may further maintain information regarding one or more actions to be initiated in response to determination occurrence of a specific touch event.

FIG. 5 discloses an example short-range communication scenario according to one embodiment of the present invention, where apparatus 200 of FIG. 1 is within short-range communication range of the other apparatuses 110, 120 &130 of FIG. 1. Apparatuses may all be capable of communicating utilizing same wireless short-range communication protocol, such as Bluetooth™. In an example usage scenario, user of apparatus 200 may desire to exchange data, such as business cards, pictures, music, multimedia files, or like with e.g. apparatus 110 wirelessly via e.g. the Bluetooth™ connection. Apparatus 200 may then initiate device discovery by transmitting one or more device discovery messages 510, 520, 530, such as ID packets according to the Bluetooth™ protocol as discussed in connection with FIG. 2. The ID packets may be general inquiry access code packets (GIAC) or DIAC packets. Apparatuses 110, 120 and 130 may then receive these device discovery messages. It should be noted that although example FIG. 5 discloses device discovery messages 510-530 as separate messages for the sake of clarity, device discovery messages are broadcast transmission so that a single device discovery message may be received by one or more of the apparatuses 110, 120 and 130.

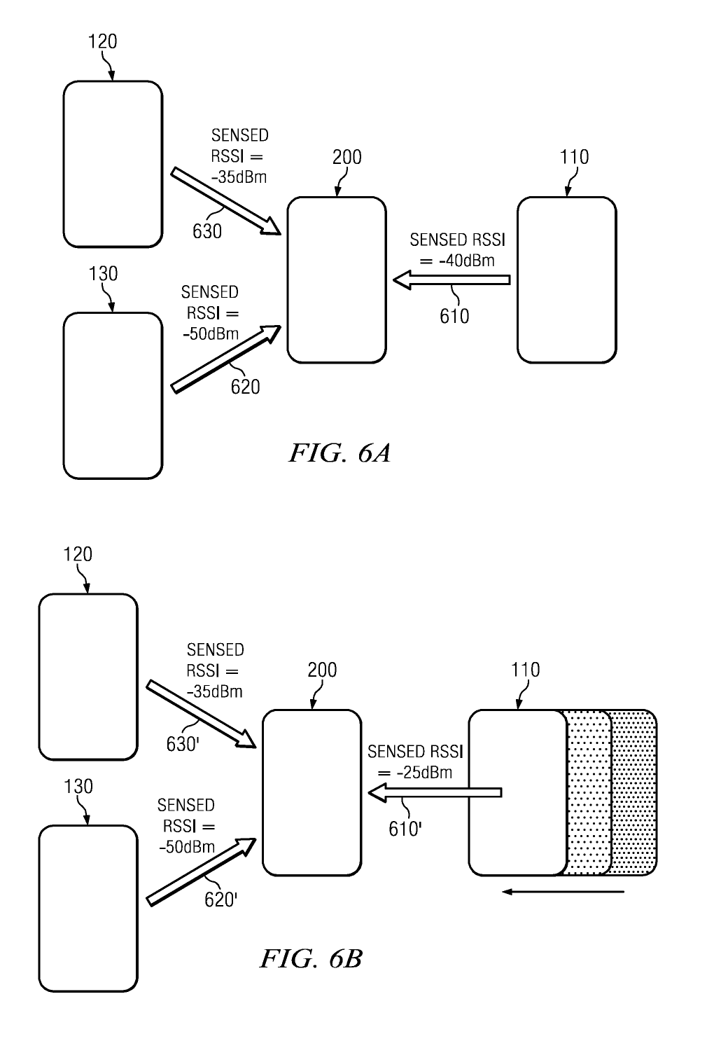

Upon receipt of one or more device discovery messages, apparatuses 110, 120 and 130 may transmit response messages to the device discovery message as referred in example FIG. 6A as 610, 620 and 630. In particular, apparatuses 110 and 120 may respond with an Extended Inquiry Response (EIR), i.e. a Frequency Hop Synchronization (FHS) packet followed by an EIR packet as disclosed in connection with example FIG. 2, while apparatus 130 may only transmit an inquiry response (IR) including just a FHS packet.

According to one embodiment of the present invention, apparatus 200 may then determine whether any of the one or more response messages satisfy predetermined criteria for triggering a touch event. Such criteria may comprise determination whether source device of the one or more response messages is within a close proximity of the apparatus 200. The proximity of the source device may be determined based on for example sensed signal strength of the received one or more response messages. So, in other words the touch event may be triggered in response to receiving one or more response messages for the transmitted device discovery messages at, or above a predetermined signal strength level. The predetermined signal strength level is set according to one example embodiment to RSSI values on or above −30 dBm. So, according to this example embodiment, sensing a response packet having −30 dBm will trigger a touch event while −31 dBm will not.

In the example of FIG. 6A, none of the received response messages satisfy the predetermined criteria for triggering touch event as none of devices 110, 120 and 130 is determined to be within close proximity of apparatus 200. As illustrated in FIG. 6A, the sensed RSSI value for response message 610 is −40 dBm, −50 dBm for response message 620 and −35 dBm for response message 630. So, none of the response messages meet or exceed the threshold value of −30 dBm for triggering the touch event.

According to one embodiment of the present invention, it is possible to determine when apparatuses are being moved closer to each other to create touch event between the apparatuses. An example of such operation is disclosed in FIG. 6B, which illustrates the example short-range communication scenario of FIG. 6A in which apparatus 110 is now moved closer to apparatus 200. Similarly, apparatus 200 may be moved closer to apparatus 110 to create the touch event between the apparatuses. Now, as disclosed in connection with FIG. 6A, apparatus 200 initially received response messages that do not satisfy the predetermined criteria for triggering touch event. However, after apparatus 110 is moved within close proximity to apparatus 200, apparatus 200 registers one or more response messages from apparatus 110 that satisfies the predetermined criteria for triggering the touch event, the sensed RSSI value for response message 610′ being −25 dBm that exceeds the exceeds the threshold value of −30 dBm for triggering the touch event.

It may also be possible that responding apparatuses send transmission power information within the Bluetooth™ EIR packet. In instances where the transmission power information is available in the EIR packet, the predetermined response criteria may include an adjustable RSSI threshold value that accounts for the transmission power. For example, the threshold value may be set at 30 dBm below the EIR transmission power, so that if the transmission power level in an FHS packet is +20 dBm then the threshold value that will trigger selection will be the FHS packet being measured at −10 dBm, or 30 dBm below of transmission power level. Further, to ensure that apparatuses are maintained in close proximity, the predetermined criteria for triggering the touch event may require that more than one Bluetooth™ FHS packet is sensed at or above a predefined threshold RSSI value. In addition, different thresholds could be used for different phases, for example, first the threshold value may be set above −45 dBm to select one or more candidate apparatuses and then second, finally deciding the threshold value may be set above −30 dBm

Another example filtering factor for selecting apparatuses for touch operations may be based on other information received in the response messages, such as capabilities and/or services that are available in a responding apparatus. For example, EIR packets may contain service level information, and so only responses above certain measured signal strength level and from device(s) capable of supporting certain types of Bluetooth™ services (e.g. RSSI above −30 dBm and OBEX file transfer supported) may be used as criteria for triggering a touch event.

According to one embodiment, upon a touch event is triggered, one or more actions may be initiated at an apparatus, such as wireless communication device 200 of FIG. 1. The one or more actions may relate to wireless connection establishment with a source apparatus that triggered the touch event and be dependent on the information received from the source apparatus in response to the transmitted device discovery messages. For example, a Bluetooth™ pairing procedure using a predetermined pairing code, such as “0000” may be initiated with the source apparatus upon a touch event is triggered in response to receiving manufacturing company and class of device information included in the Bluetooth™ FHS indicating that the source apparatus is e.g. a wireless headset from Nokia Corporation, which is not yet paired with the apparatus. Similarly, a communication connection may be initiated with a source apparatus in response to determining that the source device triggering the touch event is a paired Bluetooth™ device that is not connected with the apparatus. Alternatively, an ongoing communication connection with a source device may be disconnected in response to determining that a touch event is triggered by the source device.

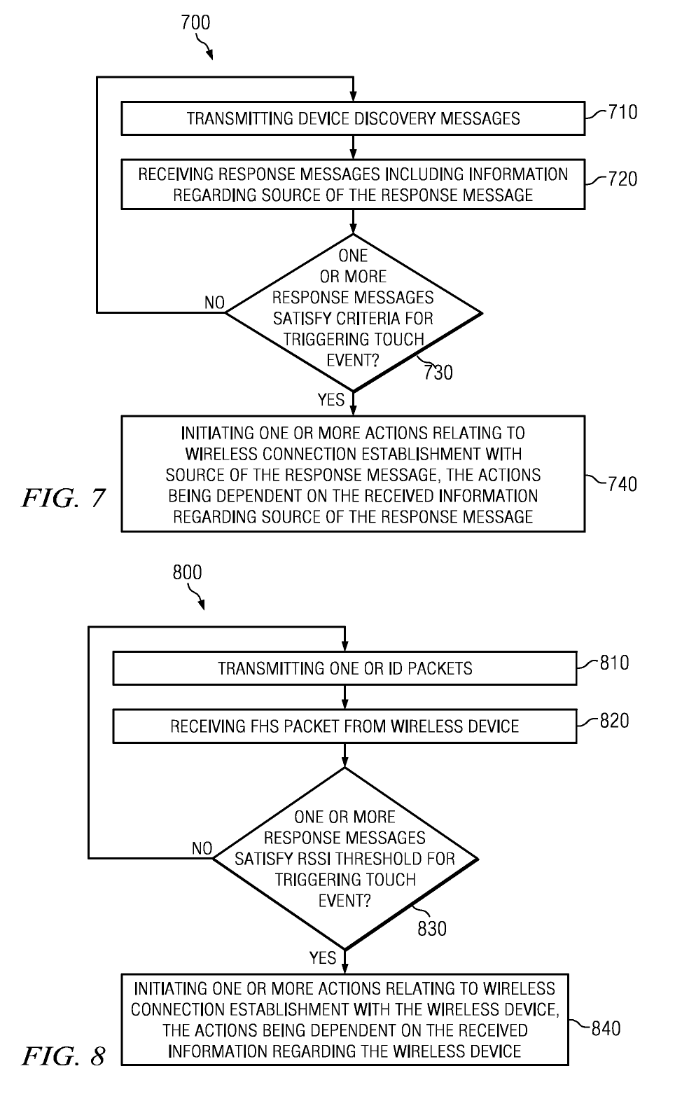

FIG. 7 illustrates an example method 700 according to one embodiment of the present invention for initiating one or more actions at an apparatus in response to detecting that another apparatus is within a close proximity. The method may also be carried out in the form of a computer process defined by a computer program. The computer program may be in source code form, object code form, or in some intermediate form, and it may be stored in some sort of distributable or a non-distributable carrier, which may be any entity or device capable of carrying the program. Such carriers include a record medium, computer memory, read-only memory, electrical carrier signal, telecommunications signal, and software distribution package, for example. Depending on the processing power needed, the computer program may be executed in a single electronic digital processing unit or it may be distributed amongst a number of processing units.

Example method 700 starts with block 710 where an apparatus, such as wireless communication device 200 of FIG. 1, transmits one or more messages to detect one or more other wireless devices, such as wireless communication devices 110, 120 and 130 of FIG. 1. Example apparatus 200 may then receive in block 720 at least one response message comprising information regarding a source device that transmitted the response message. Upon receiving the at least one response message, apparatus 200 is aware of identification information regarding other devices present in the coverage. So, the apparatus, such as the wireless communication device 200 has detected one or more wireless communication devices within its coverage.

In response to receiving the at least one response message, example method 700 continues with a decision block 730, where the wireless communication device 200 determines whether one or more of the received response messages satisfies predetermined criteria for triggering a touch event. As discussed in connection with FIGS. 6A and 6B the predetermined criteria for triggering a touch event may comprise at least determination that source of the response message is within close proximity of the apparatus 200. If it is determined that none of the received one or more response messages satisfies the predetermined criteria for triggering a touch event, method 700 goes back to block 710 where one or more device discovery messages are again transmitted to detect one or more wireless devices within coverage area of the apparatus 200.

If it is determined at block 730 that one or more response messages satisfies the predetermined criteria for triggering a touch event, method 700 continues with block 740 where one or more actions relating to wireless connection establishment with the source apparatus for the one or more messages is initiated, the one or more actions being dependent on information received regarding the source apparatus from the one or more response messages. The one or more actions relating to wireless connection establishment with the source apparatus may comprise initiation of a secure relationship with the source apparatus by creating and sharing a secret with the source apparatus. The one or more actions relating to wireless connection establishment with the source apparatus may alternatively, or in addition comprise immediate establishment of a communication connection with the source apparatus, or disconnection of an ongoing communication connection with the source apparatus based on information obtained from the received one or more response messages satisfying the predetermined criteria for triggering a touch event.

FIG. 8 illustrates an example method 800 according to one embodiment of the present invention for initiating one or more actions at an apparatus in response to detecting that another apparatus is within close proximity relating to Bluetooth™ communication protocol. The method may also be carried out in the form of a computer process defined by a computer program. The computer program may be in source code form, object code form, or in some intermediate form, and it may be stored in some sort of distributable or a non-distributable carrier, which may be any entity or device capable of carrying the program. Such carriers include a record medium, computer memory, read-only memory, electrical carrier signal, telecommunications signal, and software distribution package, for example. Depending on the processing power needed, the computer program may be executed in a single electronic digital processing unit or it may be distributed amongst a number of processing units.

Example method 800 starts with block 810 where an apparatus, such as the wireless communication device 200 of FIG. 1, transmits one or more ID packets to detect one or more discoverable Bluetooth™ devices within its coverage, such as wireless communication devices 110, 120 and 130 of FIG. 1. Example apparatus 200 may then receive at block 820, in response to the transmitted one or more ID packets, one or more response messages including at least Frequency Hop Synchronization (FHS) packets from discoverable Bluetooth™ devices. According to one embodiment, the received FHS packet corresponds with the example FHS packet illustrated in FIG. 3. The received FHS packet includes at least identification information regarding the wireless short-range communication device. Upon receiving the at least one FHS packet, apparatus 200 is aware of the identification information of discoverable Bluetooth™ devices present within the Bluetooth™ radio coverage.

In response to receiving the at least one response message, method 800 continues with a decision block 830, where the example apparatus 200 may determine whether one or more of the received FHS packets satisfies sensed RSSI threshold value for triggering a touch event. Example threshold value for triggering the touch event is set to sensed RSSI value of −30 dBm for the received FHS packet. If it is determined that none of the received FHS packets satisfies the predetermined criteria for triggering a touch event, method 800 goes back to block 810 where one or more Bluetooth™ ID packets are again transmitted.

If it is determined at block 830 that one or more of the received FHS packet satisfies the RSSI threshold value for triggering a touch event, method 800 continues with block 840 where one or more actions relating to wireless connection establishment with the source apparatus for the one or more messages is initiated, the actions being dependent on the received information regarding the source apparatus of the response message. The one or more actions relating to wireless connection establishment with the source apparatus may comprise initiation of Bluetooth™ pairing procedure with the source apparatus using predetermined pairing code based on received manufacturing company and device class information of the source apparatus that is determined to be non-paired. The one or more actions relating to wireless connection establishment with the source apparatus may alternatively, or in addition comprise immediate establishment of a communication connection with the source apparatus based on determining that the source device is a non-connected paired device, or disconnection of an ongoing communication connection with the source apparatus based on determining that the source device is a connected paired device.

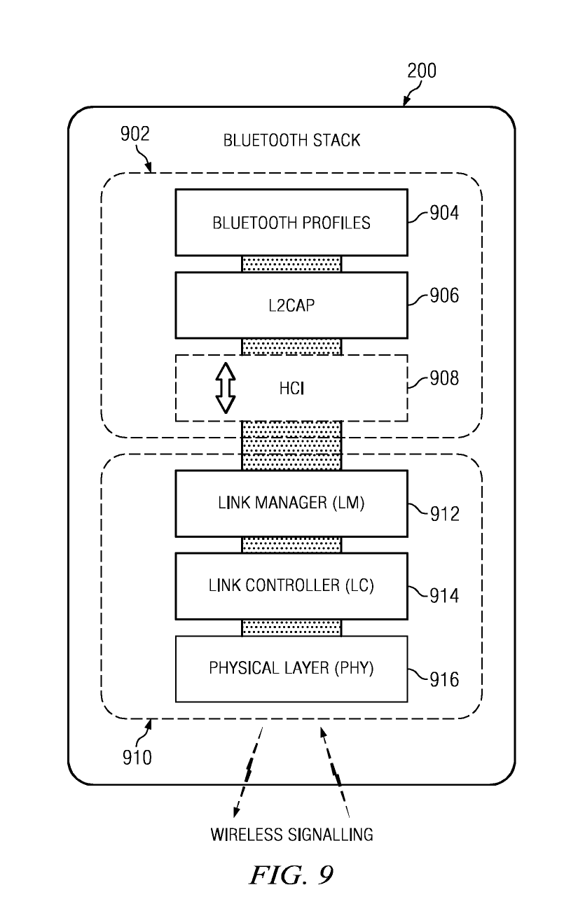

As described above, triggering of a touch event may comprise sensing of signal strength to identify that another apparatus is within close proximity. Such events may be generated by a Bluetooth™ controller (e.g., in a Bluetooth™ radio integrated circuit or “chip”) and transmitted to Bluetooth™ host (e.g., the upper-level processing resources of the apparatus) to indicate issues encountered by the Bluetooth™ controller according to one embodiment of the present invention. Example Bluetooth™ radio architecture including these entities is disclosed with respect to apparatus 200 in FIG. 9. Bluetooth™ may be visualized as a series of protocol steps (e.g., depicted as a protocol stack) when transmitting/receiving using Bluetooth™ communication protocol. The protocol stack may include elements tasked with conveying information from the system level to the physical layer where it may be transmitted wirelessly to another Bluetooth™ device. The Bluetooth™ host, which in accordance with this disclosure comprises at least the upper levels of the protocol stack as shown at 902, may interact with the Bluetooth™ controller (e.g., more generally “radio”) that comprises at least the lower portion of the protocol stack as shown at 910 via a host control interface (HCI) 908. In at least one example implementation, the Bluetooth™ host 902 may exist as software executed by processing resources within apparatus 200, while Bluetooth controller 910 may be implemented as a combined hardware and software based solution (e.g., as an integrated circuit).

Bluetooth™ Profiles 904 may include various types of definitions describing, for example, wireless communication configurations needed to access other apparatuses or standard profiles that applications may utilize when engaging in wireless communication using Bluetooth™ communication protocol. Bluetooth™ profiles 904 for other apparatuses may be established through a bonding process, called Bluetooth™ pairing. Bluetooth™ pairing is a process where apparatuses may participate in an initial interaction to exchange identification and connection information along with a shared secret that may be saved in order to expedite reconnection at a later time. After applications and/or target apparatuses are established, information to be sent must be formatted for transmission. L2CAP layer 906 includes at least a logical link controller and adaptation protocol that support higher level protocol multiplexing packet segmentation and reassembly and the conveyance of quality of service (QoS) information. Information prepared by L2CAP level 906 may then be passed to HCI 908 as defined above. This layer may act as a command interface to lower link manager protocol (LMP) layers (e.g., link manager (LM) 912 and link controller (LC) 914). LM 912 may establish link setup, authentication, configuration and may perform other protocol steps pertaining to connection establishment. LC 914 may also help to manage active links between apparatuses by handling low-level baseband protocols. Wireless packet transmission and/or reception may then be facilitated through the wireless hardware (e.g., modem, antenna, etc.) and corresponding support software associated with physical layer (PHY) 916. The disclosed Bluetooth™ protocol stack may also be utilized in an order reversed from that disclosed above in order to receive wireless transmissions. During normal operation, Bluetooth™ controller 910 may generate device discovery response events comprising RSSI information that may help to facilitate the identification of apparatuses that are within close proximity as described above.

In accordance with at least one embodiment of the present invention, the host-side Bluetooth™ controller may set circumstances in which Bluetooth events are generated, especially device discovery response events. The Bluetooth™ host may generate HCI command that may be sent to Bluetooth™ controller. HCI command generation may depend on, for example, application requirements (e.g., the activation of touch device discovery in an apparatus). For example, touch event triggering may be utilized in near proximity file sharing applications. Example applications may utilize the object exchange (OBEX) push profile to send multimedia files, pictures, etc. to remote device using touch device discovery as a means to select the destination device. For example, a file may be selected and device discovery (e.g., Bluetooth™ inquiry) may begin receiving RSSI information in order to find close proximity apparatuses. This reporting may be done with device discovery response events.

However, as described above event reporting does not necessarily happen every time an apparatus is found. In order to get apparatuses reported every time they are encountered Bluetooth™ inquiry may be run in short loops, which makes the Bluetooth™ controller reset the response event buffer and re-report already reported device again. Alternatively, Bluetooth™ host 902 to indicates to Bluetooth™ controller 910 how this event reporting needs to be done. A HCI command may be defined that indicates the manner in which device discovery response event(s) may be generated. Such a HCI command may be sent to Bluetooth™ controller 910 on different occasions. For example, a HCI command may be sent to Bluetooth™ controller 910 when apparatus 200 is activated so that device discovery event generation is the same for all applications. However this level of reporting may prove unnecessary in many device discovery situations, and thus, certain operational modes may be triggered in accordance with certain applications (e.g., close proximity file sharing).

Without in any way limiting the scope, interpretation, or application of the claims appearing below, a technical effect of one or more of the example embodiments disclosed herein may be immediate connection establishment with another device, or disconnection of an ongoing communication connection with another device when the other device is determined to be within a close proximity. Another technical effect of one or more of the example embodiments disclosed herein may be automatic bonding with another with no user involvement when the other device is determined to be within a close proximity

Various operations and/or the like described herein may be executed by and/or with the help of computers. Further, for example, devices described herein may be and/or may incorporate computers. The phrases “computer”, “general purpose computer”, and the like, as used herein, refer but are not limited to a media device, a personal computer, an engineering workstation, a personal digital assistant, a portable computer, a computerized watch, a wired or wireless terminal, phone, node, and/or the like, a set-top box, a personal video recorder (PVR), an automatic teller machine (ATM), a game console, and/or the like.

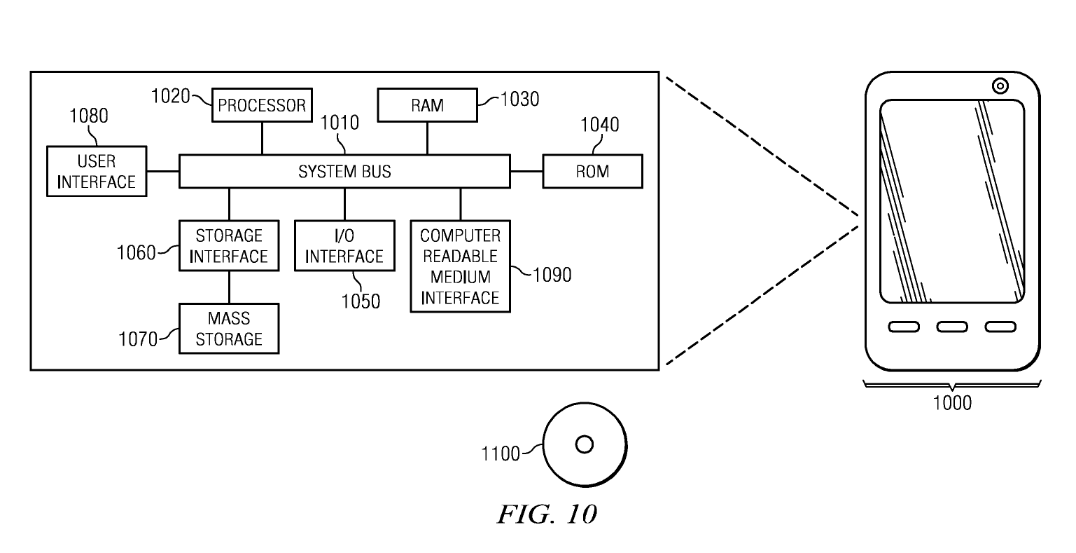

Embodiments of the present invention may be implemented in software, hardware, application logic or a combination of software, hardware and application logic. The software, application logic and/or hardware may reside on a memory of apparatus 200 of FIG. 1. In an example embodiment, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted in FIG. 10. A computer-readable medium may comprise a computer-readable storage medium that may be any media or means that may contain or store the instructions for use by or in connection with an instruction execution system, apparatus, or device, such as a computer.

The phrases “general purpose computer”, “computer”, and the like may also refer to one or more processors operatively connected to one or more memory or storage units, wherein the memory or storage may contain data, algorithms, and/or program code, and the processor or processors may execute the program code and/or manipulate the program code, data, and/or algorithms. Accordingly, example computer 1000 as shown in FIG. 10 that may be considered as one embodiment of any of the apparatuses 110, 120, 130, 140 and 200 illustrated on FIG. 1 may include various hardware modules for causing the computer to implement one or more embodiments of the present invention. According to one example, the computer 1000 include a system bus 1010 which may operatively connect processor 1020, random access memory (RAM) 1030, read-only memory (ROM) 1040 that may store for example a computer code for the computer 1000 to perform on or more of the example methods illustrated on FIGS. 7 and 8. The system bus 1010 may further operatively connect input output (I/O) interface 1050, storage interface 1060, user interface 1080 and computer readable medium interface 1090. Storage interface 1060 may comprise or be connected to mass storage 1070.

Mass storage 1070 may be a hard drive, optical drive, or the like. Processor 1020 may comprise a microcontroller unit (MCU), a digital signal processor (DSP), or any other kind of processor. Computer 1000 as shown in this example also comprises a touch screen and keys operating in connection with the user interface 1080. In various example embodiments, a mouse, and/or a keypad may alternately or additionally be employed. Computer 1000 may additionally include the computer readable medium interface 1090, which may be embodied by a card reader, a DVD drive, a floppy disk drive, and/or the like. Thus, media containing program code, for example for performing method 700 of FIG. 7, may be inserted for the purpose of loading the code onto the computer.

Computer 1000 may run one or more software modules designed to perform one or more of the above-described operations. Corresponding program code may be stored on a physical media 1100 such as, for example, DVD, CD-ROM, and/or floppy disk. It is noted that any described division of operations among particular software modules is for purposes of illustration, and that alternate divisions of operation may be employed. Accordingly, any operations discussed as being performed by a software module may instead be performed by a plurality of software modules. Similarly, any operations discussed as being performed by a plurality of modules may instead be performed by a single module. It is noted that operations disclosed as being performed by a particular computer may instead be performed by a plurality of computers.

According to one embodiment, a computer program product is provided, the computer program product comprising computer executable program code recorded on a non-transitory computer readable storage medium, the computer executable program code comprising: Code configured transmit device discovery messages; code configured to receive one or more response messages, each of the one or more response messages including information regarding a source apparatus of the response message; code configured to determine whether any of the one or more response messages satisfy a predetermined criteria for triggering a touch event; and when determining that a response messages satisfies the predetermined criteria for triggering the touch event, code configured to initiate one or more actions relating to wireless connection establishment with the source apparatus of the response message, the one or more actions being dependent on the received information regarding the source apparatus of the response message

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

1-33. (canceled)

34. A method comprising:
transmitting device discovery messages from an apparatus;
receiving one or more response messages at the apparatus, each of the one or more response messages including information regarding a source apparatus of the response message;
determining, by the apparatus, whether any of the one or more response messages satisfy a predetermined criteria for triggering a touch event; and
when determining that a response message satisfies the predetermined criteria for triggering the touch event, initiating one or more actions relating to wireless connection establishment with the source apparatus of the response message, the one or more actions being dependent on the received information regarding the source apparatus of the response message.

35. A method according to claim 34, wherein the received information regarding the source apparatus for the one or more response messages comprises at least one of an identification of the source apparatus, an indication of capabilities of the source apparatus and an indication of a manufacturing company of the source apparatus.

36. A method according to claim 34, wherein a response message satisfies the predetermined criteria for triggering the touch event when the source apparatus of the response message is determined to be in close proximity.

37. A method according to claim 34, wherein the predetermined criteria for triggering the touch event comprises receiving one or more response messages at or above a predetermined signal strength level.

38. A method according to claim 34, wherein the one or more actions relating to wireless connection establishment with the source apparatus comprises initiating Bluetooth™ pairing procedure with the source apparatus using predetermined pairing code based on received manufacturing company and device class information of non-paired source apparatus.

39. A method according to claim 34, wherein the one or more actions relating to wireless connection establishment with the source apparatus comprises immediately establishing a communication connection with the source apparatus based on determining that the source apparatus is a non-connected paired apparatus.

40. A method according to claim 34, wherein the one or more actions relating to wireless connection establishment with the source apparatus comprises disconnecting an ongoing communication connection with the source apparatus based on determining that the source apparatus is a connected paired apparatus.

41. An apparatus, comprising:
at least one processor; and
at least one memory including executable instructions, the at least one memory and the executable instructions being configured to, in cooperation with the at least one processor, cause the apparatus to perform at least the following:
transmit device discovery messages;
receive one or more response messages, each of the one or more response messages including information regarding a source apparatus of the response message;
determine whether any of the one or more response messages satisfy a predetermined criteria for triggering a touch event; and
when determining that a response message satisfies the predetermined criteria for triggering the touch event, initiate one or more actions relating to wireless connection establishment with the source apparatus of the response message, the one or more actions being dependent on the received information regarding the source apparatus of the response message.

42. An apparatus according to claim 41, wherein the received information regarding the source apparatus for the one or more response messages comprises at least one of an identification of the source apparatus, an indication of capabilities of the source apparatus and an indication of a manufacturing company of the source apparatus.

43. An apparatus according to claim 41, wherein a response message satisfies the predetermined criteria for triggering the touch event when the source apparatus of the response message is determined to be in close proximity.

44. An apparatus according to claim 41, wherein the device discovery messages and the one or more response messages comply with Bluetooth™ communication protocol.

45. An apparatus according to claim 42, wherein the identification of the source apparatus comprises a Bluetooth™ device address and the indication of capabilities of the source apparatus comprises a Bluetooth™ device class.

46. An apparatus according to claim 41, wherein the means for initiating one or more actions relating to wireless connection establishment with the source apparatus comprises means for initiating Bluetooth™ pairing procedure with the source apparatus using predetermined pairing code based on received manufacturing company and device class information of non-paired source apparatus.

47. An apparatus according to claim 41, wherein the means for initiation one or more actions relating to wireless connection establishment with the source apparatus comprises means for immediately establishing of a communication connection with the source apparatus based on determination that the source apparatus is a non-connected paired apparatus.

48. An apparatus according to claim 41, wherein the means for initiating one or more actions relating to wireless connection establishment with the source apparatus comprises means for disconnecting an ongoing communication connection with the source apparatus based on determination that the source apparatus is a connected paired apparatus.

49. A computer program product comprising computer executable code recorded on a non-transitory computer readable storage medium, the computer executable program code comprising:
code configured to transmit device discovery messages;
code configured to receive one or more response messages, each of the one or more response messages including information regarding a source apparatus of the response message;
code configured to determine whether any of the one or more response messages satisfy a predetermined criteria for triggering a touch event; and
when determining that a response messages satisfies the predetermined criteria for triggering the touch event, code configured to initiate one or more actions relating to wireless connection establishment with the source apparatus of the response message, the one or more actions being dependent on the received information regarding the source apparatus of the response message.

50. A computer program product according to claim 49, wherein the received information regarding the source apparatus for the one or more response messages comprises at least one of an identification of the source apparatus, an indication of capabilities of the source apparatus and an indication of a manufacturing company of the source apparatus.

51. A computer program product according to claim 49, wherein a response message satisfies the predetermined criteria for triggering the touch event when the source apparatus of the response message is determined to be in close proximity.

52. A computer program product according to claim 49, further comprising code configured to initiate Bluetooth™ pairing procedure with the source apparatus using predetermined pairing code based on received manufacturing company and device class information of the non-paired source apparatus.

53. A computer program product according to claim 49, further comprising code configured to immediately establish a communication connection with the source apparatus based on determination that the source apparatus is a non-connected paired apparatus.

54. A computer program product according to claim 49, further comprising code configured to disconnect an ongoing communication connection with the source apparatus based on determination that the source apparatus is a connected paired apparatus.
